(19) United States
(12) Patent Application Publication
(10) Pub. No.: US 2009/0254805 A1
(43) Pub. Date: Oct. 8, 2009

(54) METHOD OF DRAFTING A CLAIM SET

(76) Inventors: Harold W. Milton, JR., Bloomfield Hills, MI (US); Jacob Allen, Colombiaville, MI (US)

Correspondence Address: DICKINSON WRIGHT PLLC, Suite 2000, 38525 Woodward Avenue, Bloomfield Hills, MI, 48304-5092, US

(21) Appl. No.: 12/060,920

(22) Filed: Apr. 2, 2008

(51) Int. Cl. G06F 17/24

(52) U.S. Cl. 715/225

(57) ABSTRACT

A method and computer program for drafting a claim set in a patent application presents a Tool bar (20) including an Add Claim option (22). A detailed numbered claim is presented and includes a plurality of old limitations and novel limitations. By selecting the Add Claim option (22) in the Tool bar (20), a numbered claim set is presented. A broad claim is included in the claim set and includes a broad claim characterized by clause. Each of the novel limitations are automatically presented in separate sequentially numbered dependent novel claims following the broad claim in the claim set. Each of the old limitations are automatically presented in separate sequentially numbered dependent old claims following the novel claims in the claim set.

### CROSS REFERENCE TO RELATED APPLICATION

This subject application claims priority to U.S. Provisional Application No. 60/846,326, filed Sep. 21, 2006 and is related to U.S. patent application Ser. No. 09/273,021, filed Mar. 19, 1999, and Ser. No. 11/300,207 filed Dec. 14, 2005.

### BACKGROUND OF THE INVENTION

1. Field of the Invention

The present invention relates to a method of preparing a patent application including drafting a claim set in conjunction with a word processing program.

2. Description of the Prior Art

A method of preparing a patent application is disclosed in U.S. patent application Ser. No. 09/273,021, filed Mar. 19, 1999, in the name of one of the inventors herein. That method includes the steps of numbering and rearranging the order of claims and duplicating claims into the specification and assigning reference numerals to elements. Further, a method of preparing a patent application is disclosed in U.S. patent application Ser. No. 11/300,207, filed Dec. 14, 2005. That method discloses the step of, running a software macro to present a tool bar in a word processing program. An option is presented in the Tool bar on a display screen of Add Claim. A numbered claim is presented in the patent application in response to selecting Add Claim. This invention is in further perfection of the steps set forth in the aforementioned methods.

### SUMMARY OF THE INVENTION AND ADVANTAGES

The invention provides a method for preparing a patent application and adds to the prior mentioned program. The Add Claim option located on the Tool bar presents an independent claim including a detailed claim characterized by clause. A plurality of old limitations are inserted in the detailed claim prior to the detailed claim characterized by clause with each old limitation describing an old element found in the prior art. A plurality of novel limitations are inserted in the detailed claim following the detailed claim characterized by clause with each novel limitation describing a novel element absent in the prior art. The Add Claim option is again selected. A numbered claim set is presented for drafting a broad claim and a plurality of dependent claims.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a schematic view of a Tool bar utilized during the method of the subject invention;

FIG. 2 is a schematic view of an Add Claim option Block utilized during the method of the subject invention;

FIG. 3 is a schematic view of a Preamble text block utilized during the method of the subject invention;

### DETAILED DESCRIPTION OF THE INVENTION

Referring to the Figures, wherein like numerals indicate corresponding parts throughout the several views, a method and apparatus of drafting a claim set in preparing a patent application using a computer program is illustrated by showing the various steps in the form of computer screen displays.

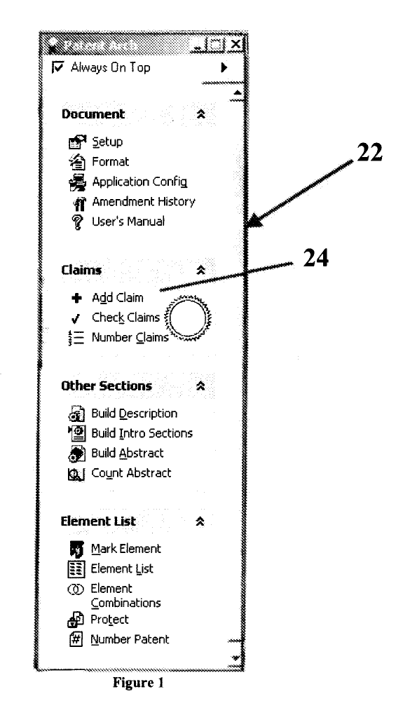

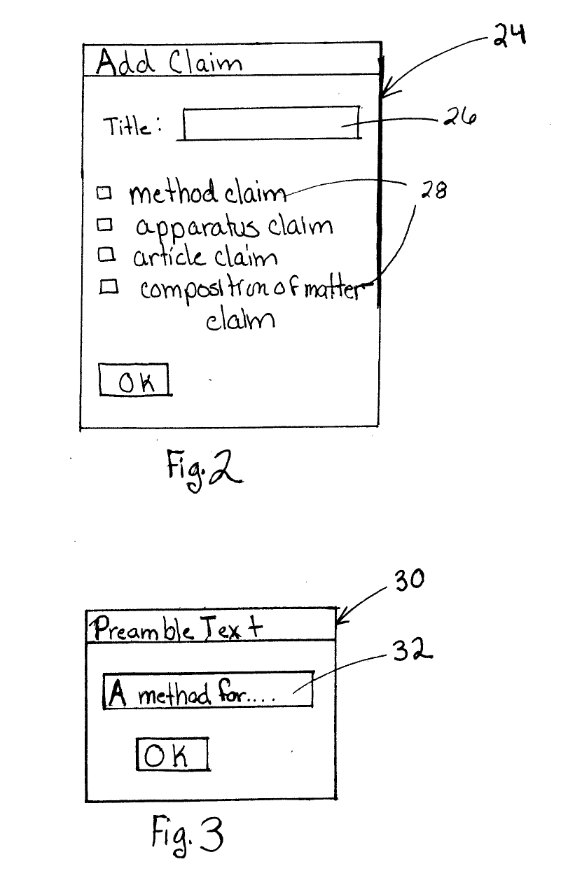

The method described is performed in conjunction with a word processing program. The program, by running a software macro, to presents a Tool bar 20 in or over a word processing program to facilitate in the drafting of a claim set for a patent application. The Tool bar 20 is illustrated in FIG. 1. Although this application describes a method for preparing a claim set, the program and its Tool bar 20 also facilitate other functions such as checking claims, checking for claim errors, numbering claims, building the description, building the introduction sections, building the abstract, counting the abstract, marking elements preparing an element list, numbering the paten, and several other functions that aid in patent drafting. These functions are covered and described in U.S. patent application Ser. No. 09/273,021, filed Mar. 19, 1999 and Ser. No. 11/300,207, filed Dec. 14, 2005.

The method begins by presenting options in the Tool bar 20 on a display screen. The first step includes selecting the Add Claim option 22 in the Tool bar 20 to present a next numbered claim. This claim is typically a detailed numbered claim, or picture claim, including a detailed claim characterized by clause and all elements of the invention. In response to selecting the Add Claim option 22, an Add Claim option block 24 is presented having a Generic Title text block 26 for including the title of the patent application and a plurality of class options 28 including a method claim option and an apparatus claim option and an article claim option and a composition of matter claim option as illustrated in FIG. 2.

A Preamble Data box 30 is displayed in response to selecting OK in the Add Claim option block 24. The Preamble Data box 30 displays the partial text of the detailed numbered claim's preamble. For instance, the text “A method for” is displayed in the Preamble Text block 32 in response to selecting the method claim option in the Add Claim option block 24. The text “An apparatus for” is displayed in the Preamble Text block 32 in response to selecting the apparatus claim option in the Add Claim option block 24. The text “An article for” is displayed in the Preamble Text block 32 in response to selecting the article claim option in the Add Claim option block 24. The text “A composition of matter comprising” is displayed in the Preamble Text block 32 in response to selecting the composition of matter claim option in the Add Claim option block 24.

The respected text in the Preamble Text block 32 is then inserted into the detailed claim 26 in response to selecting OK. Further, a form text is also displayed reading:
“comprising,
   (word picture of the prior art),
   and characterized by,
   (word picture of the novelty)” following the preamble.

For instance, if the method claim option is selected, then the first detailed claim 26 would include the text:
“A method comprising,
   (word picture of the prior art),
   and characterized by,
   (word picture of the novelty)”.

In general, a plurality of old limitations are inserted in the detailed claim 26 prior to the detailed claim characterized by clause with each old limitation describing an old element found in the prior art. A plurality of novel limitations are inserted in the detailed claim 26 following the detailed claim characterized by clause with each novel limitation describing a novel element of the present invention that is absent in the prior art.

The invention is distinguished by selecting the Add Claim option 22 in the Tool bar 20. A numbered claim set is automatically presented for drafting a broad claim 66 and for drafting a plurality of dependent claims. A broad claim 66 is automatically presented in the claim set including a broad claim characterized by clause. Each of the novel limitations are automatically presented in separate sequentially numbered dependent novel claims 84 following the broad claim 66 in the claim set. Each of the old limitations are automatically presented in separate sequentially numbered dependent old claims 86 following the novel claims 84 in the claim set.

At least one novel limitation is selected from one of the separate dependent novel claims 84 as the first most important limitation to the novelty of the invention and placed in the broad claim 66 after the broad claim characterized by clause.

Supportive old limitations are selected from the old limitations that are necessary to support the first most important limitation and placing the selected supportive old limitation in the broad claim 66 prior to the broad claim characterized by clause. A next novel limitation is selected from one of the novel claims 84 as the next most important limitation to the novelty of the invention and is placed in a sequentially numbered dependent claim 68 dependent on the broad claim 66. A next old limitation is selected from one of the old claims 100 that is necessary to support the next novel limitation as the next supportive limitation and is placed in a sequentially numbered dependent claim 68 until all the novel and old claims are exhausted.

In a specific example of the invention, a first old limitation is drafted in the detailed claim 26 prior to the detailed claim characterized by clause describing a first old element found in the present invention and in the prior art. Meaning, if an element of the present invention is found in the prior art, this element is old and should be placed before the detailed claim characterized by clause. A second old limitation is drafted in the detailed claim 26 prior to the detailed claim characterized by clause and after the first old limitation describing a second old element found in the present invention and in the prior art. A third old limitation is drafted in the detailed claim 26 prior to the detailed claim characterized by clause and after the second old limitation describing a third old element found in the present invention and in the prior art.

The old limitations are substituted for “(word picture of the prior art)” in the detailed claim 26.

A first novel limitation is drafted in the detailed claim 26 after the detailed claim characterized by clause describing a first novel element found in the present invention and absent in the prior art. In other words, this limitation contains elements not found in the prior art and are hence novel. A second novel limitation is drafted in the detailed claim 26 after the first novel limitation describing a second novel element found in the present invention and absent in the prior art. A third novel limitation is drafted in the detailed claim 26 after the second novel limitation describing a third novel element found in the present invention and absent in the prior art. The novel limitations are substituted for the text, “(word picture of the novelty)” in the detailed claim 26.

What is claimed is:

1. A method of drafting a claim set in preparing a patent application using a computer program comprising the steps of;
running a software macro to present a Tool bar (20) having an Add Claim option (22) in a word processing program,
presenting a detailed independent claim including a detailed claim characterized by clause,
inserting a plurality of old limitations in the detailed claim prior to the detailed claim characterized by clause with each old limitation describing an old element found in the.
inserting a plurality of novel limitations in the detailed claim following the detailed claim characterized by clause with each novel limitation describing a novel element absent in the prior art,
characterized by selecting Add Claim in the Tool bar (20),
presenting a numbered claim set for drafting a broad claim and for drafting a plurality of dependent claims,
presenting a broad claim in the claim set including a broad claim characterized by clause,
presenting each of the novel limitations in separate sequentially numbered dependent novel claims following the broad claim in the claim set,
presenting each of the old limitations in separate sequentially numbered dependent old claims following the novel claims in the claim set,
selecting at least one novel limitation from one of the separate dependent novel claims as the first most important limitation to the novelty of the invention, and
placing the first most important limitation in the broad claim after the broad claim characterized by clause.

2. A method as set forth in claim 1 including selecting supportive old limitations from the old limitations that are necessary to support the first most important limitation and placing the selected supportive old limitation in the broad claim prior to the broad claim characterized by clause.

3. A method as set forth in claim 2 including selecting a next novel limitation from one of the novel claims as the next most important limitation to the novelty of the invention and placing the next novel limitation in a sequentially numbered dependent claim dependent on the broad claim and selecting a next old limitation from one of the old claims that is necessary to support the next novel limitation as the next supportive limitation and placing the next old limitation in a sequentially numbered dependent claim until all the novel and old claims are exhausted.

4. A method as set forth in claim 2 including presenting the broad claim with the preamble of the detailed claim and the text:
“(only prior art necessary to support novelty)
and characterized by (novelty)”
and replacing “(novelty)” with the first most important limitation and replacing “(only prior art necessary to support novelty)” with the supportive old limitations.

5. A method as set forth in claim 1 including presenting an Add Claim option block (24) in response to selecting the Add Claim option (22) on the Tool Bar (20).

6. A method as set forth in claim 5 including a plurality of claim options in the Add Claim option block (24) including a method claim option and an apparatus claim option and an article claim option and a composition of matter claim option.

7. A method as set forth in claim 6 including displaying a Preamble Data box (30) in response to selecting OK in the Add Claim option block (24).

8. A method as set forth in claim 7 including displaying the text “A method for” in the Preamble Text block (32) in response to selecting the method claim option in the Add claim option block (24).

9. A method as set forth in claim 7 including displaying the text “An apparatus for” in the Preamble Text block (32) in response to selecting the apparatus claim option in the Add Claim option block (24),

10. A method as set forth in claim 7 including displaying the text “An article for” in the Preamble Text block (32) in response to selecting the article claim option in the Add Claim option block (24).

11. A method as set forth in claim 9 including displaying the text “A composition of matter comprising” in the Preamble Text block (32) in response to selecting the composition of matter claim option in the Add Claim option block (24).

12. A method as set forth in claim 9 including displaying the text
“comprising,
(word picture of the prior art),
and characterized by,
(word picture of the novelty)” following the preamble in the detailed claim in response to selecting OK in the Preamble Text block (32).

13. A method of drafting a claim set in preparing a patent application using a computer program comprising the steps of,
running a software macro to present a Tool bar (20) in a word processing program,
presenting an Add Claim option (22) in the Tool bar (20) on a display screen,
selecting Add Claim in the Tool bar (20) to add the next numbered claim,
presenting a detailed numbered claim,
presenting an Add Claim option block (24) having a Generic Title text block (26) for including the title of the patent application and a Preamble Text Block (32) a plurality of claim options including a method claim option and an apparatus claim option and an article claim option and a composition of matter claim option
displaying the text “A method for” and the application title in the Preamble Text block (32) in response to selecting the method claim option in the Add Claim option block (24),
displaying the text “An apparatus for” the application title in the Preamble Text block (32) in response to selecting the apparatus claim option in the Add Claim option block (24),
displaying the text “An article for” the application title in the Preamble Text block (32) in response to selecting the article claim option in the Add Claim option block (24),
displaying the text “A composition of matter comprising” the application title in the Preamble Text block (32) in response to selecting the composition of matter claim option in the Add Claim option block (24),
inserting the text in the Preamble Text block (32) in the detailed claim in response to selecting OK,
displaying the text
“comprising,
(word picture of the prior art),
and characterized by,
(word picture of the novelty)” following the preamble,
drafting a first old limitation in the detailed claim prior to the characterized by clause describing a first old element found in the present invention and in the prior art,
drafting a second old limitation in the detailed claim prior to the characterized by clause and after the first old limitation describing a second old element found in the present invention and in the prior art,
drafting a third old limitation in the detailed claim prior to the detailed claim characterized by clause and after the second old limitation describing a third old element found in the present invention and in the prior art,
substituting “(word picture of the prior art)” with the old limitations,
drafting a first novel limitation in the detailed claim after the detailed claim characterized by clause describing a first novel element found in the present invention and absent in the prior art,
drafting a second novel limitation in the detailed claim after the first novel limitation describing a second novel element found in the present invention and absent in the prior art,
drafting a third novel limitation in the detailed claim after the second novel limitation describing a third novel element found in the present invention and absent in the prior art,
substituting “(word picture of the novelty)” with the novel limitations,
characterized by selecting Add Claim in the Tool bar (20),
presenting a claim set beginning with a broad claim including the preamble of the detailed claim and the text
“(only prior art necessary to support novelty)
and characterized by (novelty)”, and inserting the first novel limitation,
presenting a third dependent claim including the phrase “An invention as set forth in claim 2 further comprising” and inserting the second novel limitation,
presenting a fourth dependent claim including the phrase “An invention as set forth in claim 3 further comprising” and inserting a third novel limitation,
presenting a fifth dependent claim including the phrase “An invention as set forth in claim 4 further comprising prior art.”,
presenting a sixth dependent claim including the phrase “An invention as set forth in claim 5 further comprising” and inserting the first old limitation,
presenting a seventh dependent claim including the phrase “An invention as set forth in claim 6 further comprising” and inserting the second old limitation,
presenting an eighth dependent claim including the phrase “An invention as set forth in claim 7 further comprising” and inserting the third old limitation,
selecting the first novel limitation being the most important element to the novelty of the invention,
substituting “(novelty)” with the first novel limitation,
selecting the third old limitation being necessary to support the structure of the first novel limitation,
substituting “(prior art)” with the third old limitation,
placing the third old limitation in the broad numbered claim before the “characterized by clause” for completing a broad independent claim,
removing the eighth dependent claim from the claim set,
selecting the second novel limitation being the second most important element to the novelty of the invention,
selecting the third novel limitation being the third most important element to the novelty of the invention,
selecting the second old limitation being the second most important element to the structure of the third novel limitation,
placing the third novel limitation in the fifth dependent claim,
removing ‘prior art’ from the fifth dependent claim, and
removing the seventh dependent claim from the claim set.
